(19) United States
(12) Patent Application Publication
(10) Pub. No.: US 2012/0328038 A1
(43) Pub. Date: Dec. 27, 2012

(54) TRANSMISSION SYSTEM, TRANSMISSION DEVICE AND METHOD FOR CONTROLLING TRANSMISSION DEVICE

(75) Inventor: Koji Ebisuzaki, Kawasaki (JP)

(73) Assignee: FUJITSU LIMITED, Kawasaki-shi (JP)

(21) Appl. No.: 13/488,508

(22) Filed: Jun. 5, 2012

(30) Foreign Application Priority Data
Jun. 22, 2011 (JP) 2011-138780

(51) Int. Cl. H04L 29/02

(52) U.S. Cl. 375/267

(57) ABSTRACT

A transmission system includes a first device; and a second device that is connected to the first device through a plurality of transmission paths, wherein the first device includes a plurality of request storage units that are provided for the transmission paths and each store a request to be transmitted to the second device, a request determining unit that determines whether a request to be transmitted to the second device is of a type that causes a redundant request, a request resource determining unit that counts the number of the requests stored in each of the plurality of request storage units and determines the number of request storage units, a request storing unit that causes a plurality of requests, generated by copying the request to be transmitted, and a plurality of request transmitters that transmit the requests stored in the plurality of storage units.

### CROSS-REFERENCE TO RELATED APPLICATION(S)

This application is based upon and claims the benefit of priority of the prior Japanese Patent Application No. 2011-138780, filed on Jun. 22, 2011, the entire contents of which are incorporated herein by reference.

### FIELD

The embodiments discussed herein are related to a transmission system, a transmission device and a method for controlling a transmission device.

### BACKGROUND

A serial transmission scheme for transmitting data with width of one bit through a transmission path is known. In addition, a technique for transmitting data through a plurality of transmission paths using a serial transmission scheme and improving a throughput for the transmission of the data between devices is known.

As an example of the technique, a computer system in which a calculating device such as a central processing unit (CPU) and an input/output processing device such as an input/output (I/O) device transmit and receive data to and from the other device through a plurality of transmission paths using the serial transmission scheme is known. An example of the computer system is described below with reference to FIG. 7. FIG. 7 is a diagram illustrating a conventional computer system. In the example illustrated in FIG. 7, the computer system 40 includes an input/output processing device 41, a calculating device 45 and a memory 49.

The input/output processing device 41 includes a request processor 42, a request transmitter 43 and a response receiver 44 and is connected to an input/output device 50. The calculating device 45 includes a request receiver 46, a response processor 47 and a response transmitter 48 and is connected to the memory 49. The request transmitter 43 and the request receiver 46 are connected to each other through a plurality of transmission paths. The response transmitter 48 and the response receiver 44 are connected to each other through a plurality of transmission paths.

The input/output processing device 41 generates, based on an input from the input/output device 50, which may be a device such as a disk device or a network interface device, a request to perform a process, such as a request to fetch data from the memory 49 or a request to store data in the memory 49, and transmits the generated request to the calculating device 45. When the calculating device 45 receives the request, the calculating device 45 performs the process in accordance with the request and transmits a response corresponding to a result of the process to the input/output processing device 41.

For the serial transmission scheme, a technique is known, which enables redundant data to be generated and transmitted when only data of a specific type is to be transmitted in order to reduce the cost of flow control and the size of a circuit for reprocessing data when a transmission error occurs.

For example, the request processor 42, which is included in the input/output processing device 41, generates, based on an input from the input/output device 50, a request, to perform a process for the aforementioned data to be transmitted, such as a request to fetch data from the memory 49 or a request to store data in the memory 49, and transmits the generated request to the request transmitter 43. When the request transmitter 43 receives the request from the request processor 42, the request transmitter 43 determines whether or not the received request is of a type that causes a redundant request to be transmitted. Specifically, the request transmitter 43 determines whether or not the received request is a request to perform a process, such as a process for storing data in the memory 49, where the input/output processing device 41 may not request the process again.

When the request transmitter 43 determines that the received request is of a type that causes a redundant request to be transmitted, the request transmitter 43 copies the received request and transmits the received request and a copy of the received request to the request receiver 46 through different transmission paths. When the request transmitter 43 determines that the received request is not of a type that causes a redundant request to be transmitted, the request transmitter 43 does not generate a redundant request and transmits the received request to the request receiver 46 through any of the transmission paths.

When the request receiver 46 receives the one or two requests from the request transmitter 43, the request receiver 46 determines whether or not an error of transmission for any of the one or two received requests has occurred. When the request receiver 46 determines that an error of transmission for any of the one or two received requests has occurred, the request receiver 46 discards the request for which the transmission error has occurred. When the request receiver 46 determines that an error of transmission for any of the one or two received requests has not occurred, the request receiver 46 determines whether or not the request receiver 46 has already received the same request as a request for which a transmission error has not occurred. When the request receiver 46 determines that the request receiver 46 has already received the same request as a newly received request, the request receiver 46 treats the newly received request as a redundant request and discards the newly received request.

After the request receiver 46 performs a process for the received request, the response processor 47 generates a response corresponding to the result for the performed process and transmits the generated response to the response transmitter 48. The response transmitter 48 determines whether or not the response that is generated by the response processor 47 is of a type that causes a redundant response to be transmitted. When the response transmitter 48 determines that the response is of a type that causes a redundant response to be transmitted, the response transmitter 48 copies the response and transmits the response and a copy of the response to the response receiver 44 through different transmission paths. When the response transmitter 48 determines that the response is not of a type that causes a redundant response to be transmitted, the response transmitter 48 transmits the response to the response receiver 44 through any of the transmission paths.

In the same manner as the request receiver 46, the response receiver 44 discards a response that is the same as a response already received, and discards a received response in which a transmission error is determined to have occurred. The response receiver 44 transmits, to the request processor 42, a response that is not discarded. After that, the request processor 42 outputs data to the input/output device 50 based on the response received from the response receiver 44. If the response receiver 44 does not receive a response to a request transmitted by the request transmitter 43 during a given time period after the transmission of the request, the request transmitter 43 retransmits the request to the request receiver 46.

The following is reference documents:
[Document 1] Japanese Laid-open Patent Publication No. 2010-050742

### SUMMARY

According to an aspect of the invention, an apparatus includes a transmission system includes: a first device; and a second device that is connected to the first device through a plurality of transmission paths, wherein the first device includes a plurality of request storage units that are provided for the transmission paths and each store a request to be transmitted to the second device, a request determining unit that determines whether or not a request to be transmitted to the second device is of a type that causes a redundant request, a request resource determining unit that counts the number of the requests stored in each of the plurality of request storage units and determines the number of request storage units that each store a number of requests whose counted number is less than equal to a given threshold, a request storing unit that causes a plurality of requests, generated by copying the request to be transmitted, to be stored in a plurality of distinct request storage units among the plurality of request storage units, and causes the plurality of requests to be stored in one of the request storage units when the request determining unit determines that the request to be transmitted is not of the type that causes a redundant request and the request resource determining unit determines that there is not a plurality of request storage units that each store a number of requests whose counted number is less than or equal to the given threshold, and a plurality of request transmitters that transmit the requests stored in the plurality of storage units through distinct transmission paths among the plurality of transmission paths.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a computer system according to a first embodiment;

FIG. 2 is a diagram illustrating an example of a request packet that is generated by a request processor;

FIG. 3 is a diagram illustrating an example of a request transmitter according to the first embodiment;

FIG. 4 is a diagram illustrating an example of a response transmitter according to the first embodiment;

FIG. 5 is a flowchart of an example of a process to transmit a request packet that is performed by the request transmitter according to the first embodiment;

FIG. 6 is a flowchart of an example of a process to transmit a request packet that is not of a type that causes a redundant request that is performed by the request transmitter according to the first embodiment in order; and

FIG. 7 is a diagram illustrating a conventional transmission device.

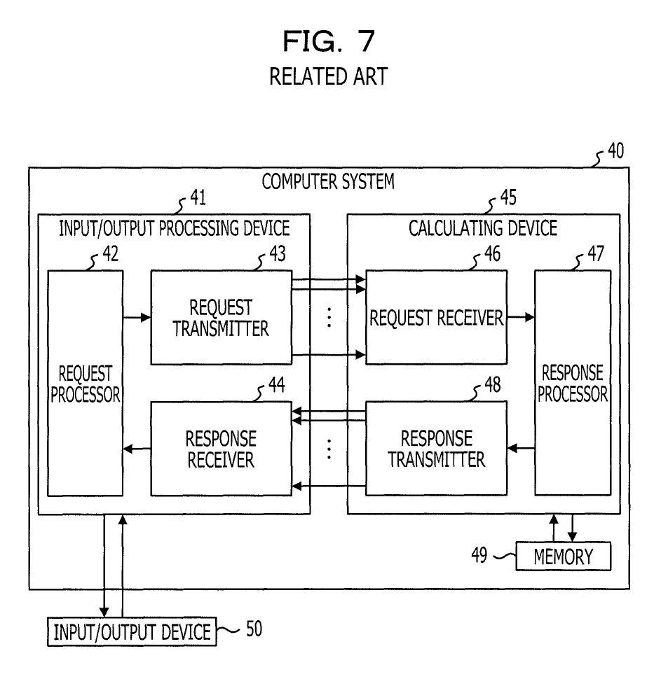

### DESCRIPTION OF EMBODIMENTS

Hereinafter, a transmission system, a transmission device, and a method for controlling a transmission device are described with reference to the accompanying drawings.

### First Embodiment

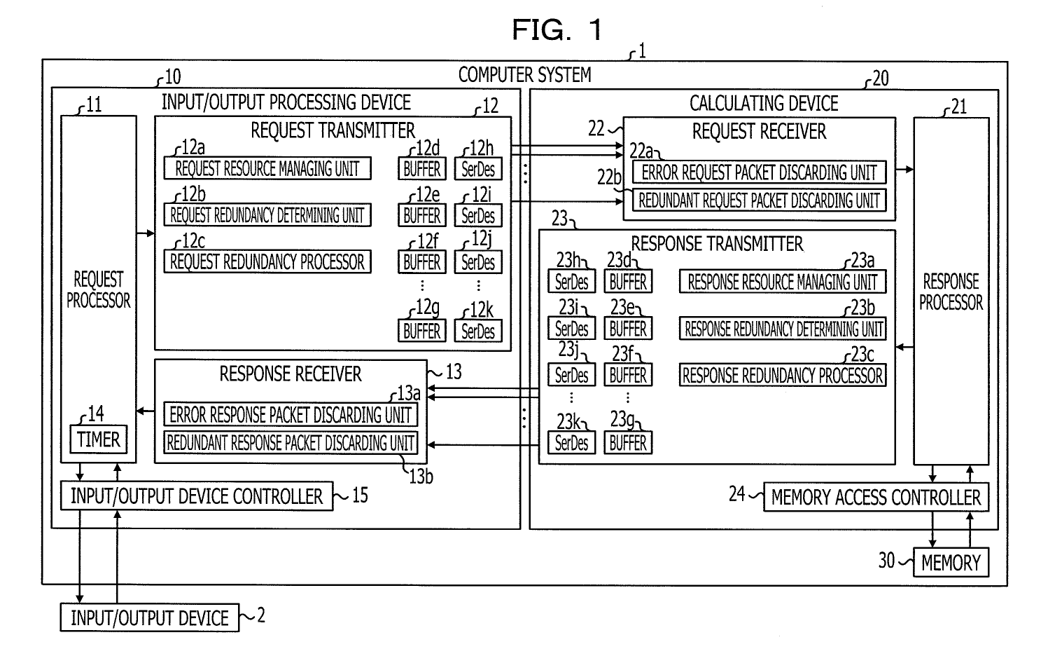

A first embodiment describes an example of a computer system that has a plurality of devices that transmit and receive one or more requests and one or more responses using a serial transmission scheme. FIG. 1 is a diagram illustrating a computer system 1 according to the first embodiment.

In the example illustrated in FIG. 1, the computer system 1 includes an input/output processing device (I/O device) 10, a calculating device 20 and a memory 30. The computer system 1 is connected to an input/output device 2. The input/output device 2 is a device, such as a disk device or a network interface device. The memory 30 may store various types of data.

The input/output processing device 10 has therein a request processor 11, a request transmitter 12, a response receiver 13 and an input/output device controller 15. The input/output device controller 15 is an interface that is connected to the input/output device 2. The request processor 11 has a timer 14. The request transmitter 12 includes a request resource managing unit 12a, a request redundancy determining unit 12b, a request redundancy processor 12c, a plurality of buffers 12d to 12g and a plurality of serializers/deserializers (SerDes) 12h to 12k. The response receiver 13 includes an error response packet discarding unit 13a and a redundant response packet discarding unit 13b.

The calculating device 20 includes a response processor 21, a request receiver 22, a response transmitter 23 and a memory access controller 24. The request receiver 22 includes an error request packet discarding unit 22a and a redundant request packet discarding unit 22b. The response transmitter 23 includes a response resource managing unit 23a, a response redundancy determining unit 23b, a response redundancy processor 23c, a plurality of buffers 23d to 23g and a plurality of SerDeses 23h to 23k.

The request processor 11 requests, based on an input from the input/output device 2, the calculating device 10 to perform a given process. When the response receiver 13 receives a response to a request transmitted by the request transmitter 12, the request processor 11 transmits, to the input/output device 2 and based on the received response, a result of the process performed based on the request. The request processor 11 has a timer 14 that monitors a timeout.

For example, the request processor 11 acquires, from the input/output device 2 through the input/output device controller 15, a request to fetch data from the memory 30. After acquiring the fetch request, the request processor 11 generates a request packet that includes information that indicates the fetch request. The request processor 11 transmits, to the request redundancy determining unit 12b of the request transmitter 12, an instruction to transmit the request packet that includes the information that indicates the fetch request. When the request redundancy determining unit 12b of the request transmitter 12 instructs the request processor 11 to transmit the request packet that includes the information that indicates the fetch request, the request processor 11 transmits, to the request redundancy processor 12c, the generated request packet that includes the information that indicates the fetch request.

For example, the request processor 11 acquires, from the input/output device 2 through the input/output device controller 15, a request (store request) to store data in the memory 30. After acquiring the store request, the request processor 11 generates a request packet that includes both the data to be stored in the memory 30 and information that indicates the store request. The request processor 11 transmits, to the request redundancy determining unit 12b of the request transmitter 12, an instruction to transmit the request packet that includes the information that indicates the store request. When the request redundancy determining unit 12b of the request transmitter 12 instructs the request processor 11 to transmit the request packet that includes the store request, the request processor 11 transmits, to the request redundancy processor 12c, the generated request packet that includes the store request.

When the response receiver 13 receives a response (fetch response) to the fetch request, the request processor 11, based on the received fetch response, outputs the data fetched from the memory 30 and a notification indicating completion of the fetch request to the input/output device 2. When the response receiver 13 receives a response (that is, a store response) to the store request, the request processor 11, based on the received store response, outputs a notification indicating completion of the store request to the input/output device 2.

When the request processor 11 transmits, to the request transmitter 12, an instruction to transmit a request that is not of a type that causes a redundant request, the request processor 11 uses the timer 14 to monitor a time period from the time when the instruction is transmitted until the time when the request processor 11 receives a response to the request from the calculating device 20 through the response receiver 13. When the request processor 11 does not receive, from the response receiver 13 and within a given time period, a response packet corresponding to the request packet transmitted by the request transmitter 12 that has received the instruction as a result of the monitoring performed by the request processor 11 using the timer 14, the request processor 11 instructs the request transmitter 12 to transmit the request again.

Specifically, when the request processor 11 instructs the request transmitter 12 to transmit the request, the request processor 11 sets the timer 14. When the timer 14 notifies the request processor 11 of a timeout, in other words when the request processor 11 does not receive a response to the transmitted request from the response receiver 13 within the given time period, the request processor 11 instructs the request redundancy processor 12c to retransmit the request. When the request processor 11 instructs the request redundancy processor 12c, which is described later, to retransmit the request, the request redundancy processor 12c retransmits the request packet stored in at least one of the buffers 12d to 12g to the request receiver 22 of the calculating device 20.

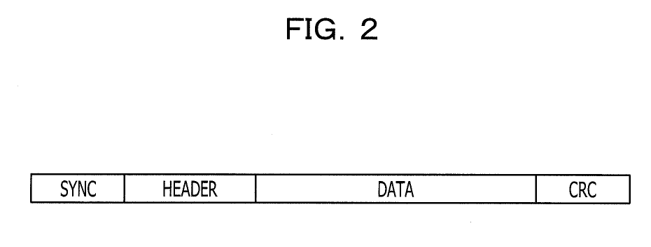

Next, an example of a request packet that is generated by the request processor 11 is described with reference to FIG. 2. FIG. 2 is a diagram illustrating an example of a request packet generated by the request processor 11. In the example illustrated in FIG. 2, a request packet includes an SYNC region and a header region. Information that indicates the beginning of the request packet is stored in the SYNC region. The size of the request packet and a destination of the request packet are stored in the header region. In addition, the request packet includes a data region and a cyclic redundancy check (CRC) region. Details of the request are stored in the data region. Information that is used to perform a CRC in order to detect an error of transmission of the data region of the request packet is stored in the CRC region. An arbitrary length of the information that is stored in the CRC region may be selected based on the CRC to be performed. For example, 9 bits of information are stored in the CRC region when an 8-bit CRC is to be performed, 17 bits of information are stored in the CRC region when a 16-bit CRC is to be performed, 33 bits of information are stored in the CRC region when a 32-bit CRC is to be performed, and 65 bits of information are stored in the CRC region when a 64-bit CRC is to be performed.

Returning to FIG. 1, the request transmitter 12 determines whether or not the request that is included in the request packet to be transmitted to the calculating device 20 is of a type that causes a redundant request. When the request transmitter 12 determines that the request that is included in the request packet to be transmitted to the calculating device 20 is of the type that causes a redundant request, the request transmitter 12 copies the request packet to be transmitted and transmits the request packet and at least one copy of the request packet to the calculating device 20 through different transmission paths.

When the request transmitter 12 determines that the request that is included in the request packet to be transmitted to the calculating device 20 is not of a type that causes a redundant request, the request transmitter 12 performs the following process. That is, the request transmitter 12 determines, out of the transmission paths, whether or not there is a plurality of transmission paths, in each of which the number of request packets being transmitted is less than a given threshold. In other words, the request transmitter 12 determines whether or not there is a plurality of transmission paths whose transmission bands are available. When the request transmitter 12 determines that there is a plurality of transmission paths whose transmission bands are available, the request transmitter 12 copies the request packet to be transmitted to the calculating device 20 and transmits separately the request packet and at least one copy of the request packet to the calculating device 20 through the plurality of transmission paths whose transmission bands are available. On the other hand, when the request transmitter 12 determines that there is not a plurality of transmission paths whose transmission bands are available, the request transmitter 12 does not copy the request packet and transmits the request packet to the calculating device 20 through any of the transmission paths.

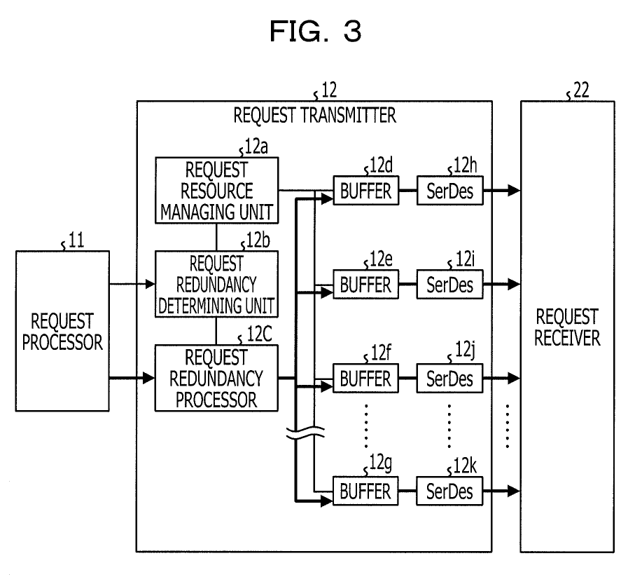

A specific example of the request transmitter 12 is described below with reference to FIG. 3. FIG. 3 is a diagram illustrating an example of the request transmitter 12 according to the first embodiment. For example, the request transmitter 12 has the buffers 12d to 12g and the SerDeses 12h to 12k, which correspond to the transmission paths through which request packets are transmitted to the request receiver 22. Each of the buffers 12d to 12g is a buffer that temporarily stores one or more request packets that are to be transmitted through a transmission path that is different to other transmission paths. Each of the SerDeses 12h to 12k acquires the one or more request packets stored in corresponding buffer out of the buffers 12d to 12g, converts the acquired one or more request packets into serial data, and transmits the converted serial data to the request receiver 22 through the corresponding transmission path that is different to the other transmission paths. Thus, the SerDeses 12h to 12k are transmitting units that transmit the request packets to the request receiver 22 using a serial transmission scheme.

The request resource managing unit 12a counts the number of request packets stored in each of the buffers 12d to 12g separately. For example, every time a request packet is stored in any of the buffers 12d to 12g, the request resource managing unit 12a increments the buffer's number of request packets. Every time a request packet is transmitted from any of the buffers 12d to 12g, the request resource managing unit 12a decrements the buffer's number of request packets. In addition, every time a given time period elapses, the request resource managing unit 12a transmits, to the request redundancy determining unit 12b, a notification that indicates the number of request packets stored in each of the buffers 12d to 12g.

The request redundancy determining unit 12b receives, from the request resource managing unit 12a, the notification that indicates the number of request packets stored in each of the buffers 12d to 12g. In addition, when the request redundancy determining unit 12b receives information about the type of a request from the request processor 11, the request redundancy determining unit 12b determines whether or not the request is of a type that causes a redundant request.

When the request redundancy determining unit 12b determines that the request is of the type that causes a redundant request, the request redundancy determining unit 12b performs the following process in order to store a request packet that is a target of redundancy and at least one redundant request packet generated by copying the request packet into a plurality of buffers each corresponding to different transmission paths. That is, the request redundancy determining unit 12b determines, based on the number of the request packets stored in each of the buffers 12d to 12g, which is indicated in the notification transmitted by the request resource managing unit 12a, whether or not there are buffers (hereinafter referred to as available buffers) that are among the buffers 12d to 12g and have available capacities for the number of redundant request packets, which is the number of request packets including the request packet that is a target of redundancy and the at least one redundant request packet generated by copying the request packet that is a target of redundancy, in other words, whether or not there are buffers among the buffers 12d to 12g that have capacity available to store the request packets.

For example, when the request packet that is a target of redundancy and a single redundant request packet generated by copying the request packet that is a target of redundancy are to be stored (that is, when the number of the redundant request packets is 2), the request redundancy determining unit 12b determines whether or not there are two or more available buffers. When the request packet that is a target of redundancy and two redundant request packets generated by copying the request packet that is a target of redundancy are to be stored (that is, when the number of the redundant request packets is 3), the request redundancy determining unit 12b determines whether or not three or more available buffers exist. When the request redundancy determining unit 12b determines that the number of available buffers is equal to the number of redundant request packets, the request redundancy determining unit 12b selects all the available buffers.

When the request redundancy determining unit 12b determines that the number of available buffers is larger than the number of redundant request packets, the request redundancy determining unit 12b uses a method, such as round robin method, to select buffers from among the plurality of available buffers so that the number of the selected buffers is equal to the number of the redundant request packets. After that, the request redundancy determining unit 12b transmits, to the request redundancy processor 12c, a notification that includes information specifying the selected buffers and information indicating that the request packet is to be made redundant.

When the request redundancy determining unit 12b determines that the number of available buffers is less than the number, as indicated in the notification transmitted by the request resource managing unit 12a, of the redundant request packets, the request redundancy determining unit 12b waits for a certain time period and receives again a notification from the request resource managing unit 12a that indicates the number of the request packets that are the request packet that is a target of redundancy and the at least one redundant request packet and are to be stored in the buffers 12d to 12g. After that, the request redundancy determining unit 12b determines whether or not available buffers exist based on the number, which is indicated in the re-received notification, of the request packets to be stored in the buffers 12d to 12g.

When the request redundancy determining unit 12b determines that the request packet is not of a type that causes redundant requests, the request redundancy determining unit 12b performs the following process, based on the number of available buffers capable of storing the request packet, in order to store the request packet in one or more buffers. That is, the request redundancy determining unit 12b determines whether or not there is a plurality of available buffers. When the request redundancy determining unit 12b determines that there is only one available buffer, the request redundancy determining unit 12b selects the available buffer as a buffer for storing the request packet. Afterwards, the request redundancy determining unit 12b transmits, to the request redundancy processor 12c, a notification including information specifying the selected one or more buffers and information indicating that the request packet is not to be made redundant.

When the request redundancy determining unit 12b determines that a plurality of available buffers exist and even when the request packet is not of a type that causes redundant requests, the request redundancy determining unit 12b performs the following procedure in order to generate a redundant request packet. That is, when the request redundancy determining unit 12b determines that a plurality of available buffers exist, the request redundancy determining unit 12b selects the plurality of available buffers as buffers to store the request packets, based on a prespecified number (hereinafter referred to as the prespecified number of request packets to be redundant) of request packets that are the request packet that is a target of redundancy and at least one redundant request packet to be generated by copying the request packet that is a target of redundancy.

For example, when the prespecified number of request packets to be redundant is 2, and the request packet that is a target of redundancy and a single redundant request packet to be generated by copying the request packet that is a target of redundancy are to be stored, the request redundancy determining unit 12b determines whether or not two or more available buffers exist. When the prespecified number of request packets to be redundant is 3, and the request packet that is a target of redundancy and two redundant request packets to be generated by copying the request packet that is a target of redundancy are to be stored, the request redundancy determining unit 12b determines whether or not three or more available buffers exist. When the request redundancy determining unit 12b determines that the number of available buffers is equal to the prespecified number of request packets to be redundant, the request redundancy determining unit 12b selects all the plurality of available buffers.

When the request redundancy determining unit 12b determines that the number of available buffers is larger than the prespecified number of request packets to be redundant, the request redundancy determining unit 12b uses a method, such as a round robin method, to select buffers from among the plurality of available buffers based on the number of redundant request packets generated by copying the request packet so that the number of the buffers selected to store the request packets is equal to the prespecified number of request packets to be redundant. Afterwards, the request redundancy determining unit 12b transmits, to the request redundancy processor 12c, a notification including information specifying the selected buffers and information indicating that the request packet is to be made redundant.

When the request redundancy determining unit 12b determines that not even one available buffer exists, the request redundancy determining unit 12b waits for a certain time period or waits until a buffer becomes available by outputting another request packet currently stored in any of the buffers 12d to 12g. After that, if a single buffer becomes available, the request redundancy determining unit 12b selects the available buffer. If a plurality of buffers becomes available, the request redundancy determining unit 12b uses a method, such as a round robin method, to select, from among the plurality of available buffers, a buffer to store the request packet. After that, the request redundancy determining unit 12b transmits, to the request redundancy processor 12c, a notification including information about the selected single buffer and information indicating that the request packet is not to be made redundant.

When the request redundancy determining unit 12b determines that a request that is to be newly transmitted is of a type that causes a redundant request, the request redundancy processor 12c, which is described later, makes a request packet redundant by directing the transmission of request packets stored in selected available buffers. If there are a plurality of available buffers, even if the request redundancy determining unit 12b determines that the request that is to be newly transmitted is not of a type that causes a redundant request, the request redundancy processor 12c makes a request packet redundant by directing the transmission of the request packets stored in the selected available buffers. Specifically, when the request redundancy determining unit 12b determines that at least one of the buffers 12d to 12g, which are provided for the transmission paths, is available, the request redundancy processor 12c generates a redundant request packet from the request packet that is a type that doesn't causes a redundant request, and causes the request packets to be transmitted to the request receiver 22. Thus, the request redundancy determining unit 12b may reduce the possibility of retransmission of the request packet caused by a transmission error.

The request redundancy determining unit 12b determines that a request for a process that is performed by the calculating device 20 and whose order of procedures is desired to be guaranteed is a request of a type that causes a redundant request. Executing the request for the process whose order of the procedures is desired to be guaranteed affects the result of a process to be performed based on another request. Thus, the request for the process whose order of the procedures is desired to be guaranteed is a request that is not simply re-executed. For example, the request redundancy determining unit 12b determines that a store request and an interrupt request to be provided to the calculating device 20 are requests that are each of a type that causes a redundant request.

When the request redundancy processor 12c receives, from the request redundancy determining unit 12b, the notification including information specifying the plurality of buffers selected by the request redundancy determining unit 12b and information indicating that the request packet is to be made redundant, the request redundancy processor 12c instructs the request processor 11 to transmit the request packet and acquires the request packet from the request processor 11. Then, the request redundancy processor 12c copies the acquired request packet depending on the number of redundant request packets or the prespecified number of request packets to be redundant and causes the received request packet and at least one copy of the request packet to be stored in the buffers indicated in the information, which specified the selected buffers, that is included in the notification acquired from the request redundancy determining unit 12b.

When the request redundancy processor 12c receives, from the request redundancy determining unit 12b, the notification that includes information specifying a single buffer selected by the request redundancy determining unit 12b and information indicating that the request packet is not to be made redundant, the request redundancy processor 12c instructs the request processor 11 to transmit the request packet and acquires the request packet from the request processor 11. Then, the request redundancy processor 12c causes the received request packet to be stored in the buffer indicated by the information, which specifies the selected buffer, that is included in the notification received from the request redundancy determining unit 12b.

Even if the request that is indicated in the request packet to be transmitted is not of a type that causes a redundant request, if any of the buffers that are provided for the transmission paths is available, the request transmitter 12 makes the request packet redundant by causing a copy of the request packet to be stored in the available buffer, which corresponds to another transmission path, and transmitting the request packet. Thus, the request transmitter 12 effectively uses the transmission paths, reduces the number of times of retransmission of a request packet caused by either the occurrence of an error of transmission of the request packet or the occurrence of a timeout, and may prevent a latency of data transmission from increasing.

Returning to FIG. 1, the response receiver 13 receives response packets transmitted through the plurality of transmission paths from the response transmitter 23. The response receiver 13 discards a response packet for which a transmission error has occurred. When a transmission error does not occur and the response receiver 13 receives duplicate packets, the response receiver 13 transmits any of the duplicate packets to the request processor 11 and discards the remaining one or more duplicate packets.

Next, processes that are performed by the error response packet discarding unit 13a and redundant response packet discarding unit 13b of the response receiver 13 are described. When the error response packet discarding unit 13a receives an error packet from the calculating device 20, in other words when an error occurs in a packet received by the error response packet discarding unit 13a, the error response packet discarding unit 13a performs a process to discard the error packet.

For example, a response packet has a CRC region in which information that is used to perform a CRC in order to detect a transmission error is stored. The error response packet discarding unit 13a uses information stored in the CRC region of a response packet, performs a process to check the CRC, and determines whether or not an error of transmission has occurred in the response packet. Then, the error response packet discarding unit 13a discards, based on results of the process to check the CRC, a response packet determined to be a response packet in which a transmission error has occurred. The error response packet discarding unit 13a transmits, to the redundant response packet discarding unit 13b, a response packet determined to be a response packet in which a transmission error has not occurred.

When the redundant response packet discarding unit 13b newly receives a normal response packet from the error response packet discarding unit 13a, the redundant response packet discarding unit 13b determines whether or not the redundant response packet discarding unit 13b has already received a duplicate of the newly received response packet. When the redundant response packet discarding unit 13b determines that the redundant response packet discarding unit 13b has already received a duplicate of the newly received response packet, the redundant response packet discarding unit 13b discards the newly received response packet. In other words, when the redundant response packet discarding unit 13b receives a plurality of response packets from the error response packet discarding unit 13a for a given request, the redundant response packet discarding unit 13b discards a response packet other than the first received response packet. In addition, when the redundant response packet discarding unit 13b determines that the redundant response packet discarding unit 13b does not receive a duplicate of the newly received response packet, the redundant response packet discarding unit 13b acquires response data from the newly received response packet and transmits the acquired response data to the request processor 11. When the request processor 11 receives a response from the response receiver 13, the request processor 11 resets the set timer 14.

When the request processor 11 does not receive a response packet from the calculating device 20 through the response receiver 13 within a given time period after the transmission of the request packet from the request processor 11 to the request redundancy processor 12c, the timer 14 notifies the request transmitter 12 of the timeout. In other words, when the timer 14 is not reset based on the response data transmitted from the redundant response packet discarding unit 13b within the given time period after the transmission of the request packet to the request redundancy processor 12c, the timer 14 notifies the request transmitter 12 of the timeout.

Next, the parts that are included in the calculating device 20 are described. When the response processor 21 receives a request from the request receiver 22, the response processor 21 processes the received request and performs a process to generate a response. For example, when the request that is received by the response processor 21 is a fetch request or a store request, the response processor 21 reads or writes data from or in the memory 30 through the memory access controller 24. The memory access controller 24 is a memory controller that controls access to data stored in the memory 30.

The response processor 21 generates a response packet, which includes a response, in a similar manner to the request processor 11 and transmits, to the response redundancy determining unit 23b, a notification indicating the type of the response. When the response processor 21 receives, from the response redundancy processor 23c, a notification that the response is to be transmitted, the response processor 21 transmits the generated response packet to the response redundancy processor 23c. The response packet that is generated by the response processor 21 has a SYNC region, a header region, a data region and a CRC region in the same manner as the request packet generated by the request transmitter 12, and a description thereof is omitted.

The response transmitter 23 determines whether or not the response that is included in the response packet to be transmitted to the input/output processing device 10 is of a type that causes a redundant response, in the same manner as the request transmitter 12. In other words, the response transmitter 23 determines whether or not the response that is included in the response packet is a response for a result of processing a request whose order of procedures is desired to be guaranteed. When the response transmitter 23 determines that the response is of a type that causes a redundant response, the response transmitter 23 copies the response packet, thereby generates a redundant response packet and transmits the response packets to the response receiver 13 of the input/output processing device 10 through different transmission paths.

When the response transmitter 23 determines that the response is not of a type that cause a redundant response, the response transmitter 23 determines whether or not there is a plurality of transmission paths, in each of which the number of response packets being transmitted is less than a given threshold, in other words the response transmitter 23 determines whether or not there is a plurality of transmission paths whose transmission bands are available. When the response transmitter 23 determines that there is a plurality of transmission paths whose transmission bands are available, the response transmitter 23 copies the response packet, thereby generating a redundant response packet and transmits the redundant response packets to the response receiver 13 through different transmission paths. When the response transmitter 23 determines that a plurality of transmission paths whose transmission bands are available do not exist, the response transmitter 23 does not generate a redundant response packet and transmits the response packet to the response receiver 13 through any of the transmission paths.

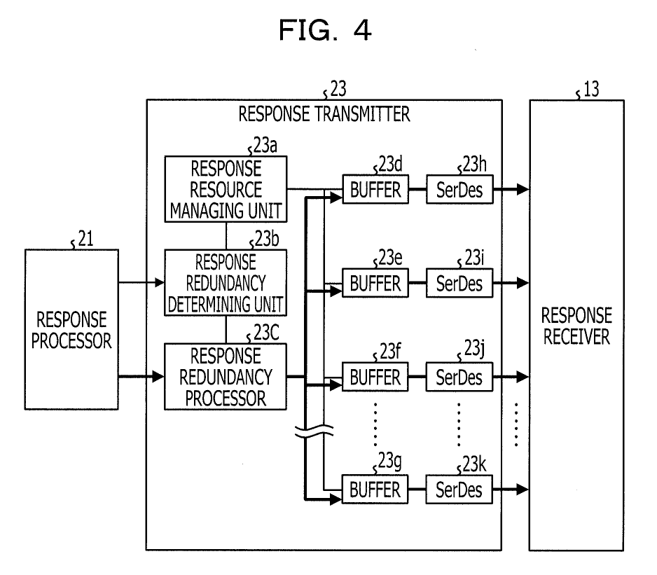

Next, the parts that are included in the response transmitter 23 are described with reference to FIG. 4. FIG. 4 is a diagram illustrating an example of the response transmitter 23 according to the first embodiment. The buffers 23d to 23g have the same function as the buffers 12d to 12g of the request transmitter 12. The SerDeses 23h to 23k have the same function of the SerDeses 12h to 12k of the request transmitter 12. Thus, a description of the buffers 23d to 23g and the SerDeses 23h to 23k is omitted.

The response resource managing unit 23a counts the numbers of response packets stored in the buffers 23d to 23g in the same manner as the request resource managing unit 12a and transmits, to the response redundancy determining unit 23b, a notification indicating the counted number of the response packets.

The response redundancy determining unit 23b receives, from the response processor 21, notification of information about the type of a response to be newly transmitted and receives a notification indicating the number of response packets stored in the buffers 23d to 23g from the response resource managing unit 23a. When the response redundancy determining unit 23b receives information about the type of the response from the response processor 21, the response redundancy determining unit 23b determines whether or not the response is of a type that causes a redundant response.

When the response redundancy determining unit 23b determines that the response is of a type that causes a redundant response, the response redundancy determining unit 23b performs the following process in order to store the response packet that is a target of redundancy and at least one redundant response packet, generated by copying the response packet that is a target of redundancy, in a plurality of buffers corresponding to different transmission paths.

The response redundancy determining unit 23b determines, based on the number of response packets stored in the buffers 23d to 23g, the number being indicated in the notification transmitted from the response resource managing unit 23a, whether or not there are available buffers that have available capacity for the number of the response packets that are the response packet that is a target of redundancy and the at least one redundant response packet generated by copying the response packet that is a target of redundancy, in other words whether or not there are available buffers that have available capacities to store the response packets.

For example, when the response packet that is a target of redundancy and a single redundant response packet generated by copying the response packet that is a target of redundancy are to be stored (that is, when the number of the redundant response packets is 2), the response redundancy determining unit 23b determines whether or not two or more available buffers exist. When the response packet that is a target of redundancy and two redundant response packets generated by copying the response packet that is a target of redundancy are to be stored (that is, when the number of the redundant response packets is 3), the response redundancy determining unit 23b determines whether or not three or more available buffers exist. When the response redundancy determining unit 23b determines that the number of available buffers is equal to the number of the redundant response packets, the response redundancy determining unit 23b selects all the available buffers.

When the response redundancy determining unit 23b determines that the number of available buffers is larger than the number of the redundant response packets, the response redundancy determining unit 23b uses a method, such as a round robin method, to select buffers from among the plurality of available buffers so that the number of the selected buffers is equal to the number of the redundant response packets. After that, the response redundancy determining unit 23b transmits, to the response redundancy processor 23c, a notification including information specifying the selected buffers and information indicating that the response packet is to be made redundant.

When the response redundancy determining unit 23b determines that the number of available buffers is less than the number, which is indicated in the notification transmitted from the response resource managing unit 23a, of the response packets that are the response packet that is a target of redundancy and the at least one redundant response packet generated by copying the response packet that is a target of redundancy, the response redundancy determining unit 23b waits for a certain time period and receives again a notification from the resource response managing unit 23a indicating the number of the response packets that are the response packet that is a target of redundancy and at least one redundant response packet, in other words indicating the number of the response packets to be stored in the buffers 23d to 23g. After that, the response redundancy determining unit 23b determines, based on the number, which is indicated in the received notification, of the response packets to be stored in the buffers 23d to 23g, whether or not available buffers exist.

When the response redundancy determining unit 23b determines that the response is not of a type that cause a redundant response, the response redundancy determining unit 23b performs the following process depending on the number of available buffers in order to store the response packet in at least one of the buffers 23d to 23g. That is, the response redundancy determining unit 23b determines whether or not there is a plurality of available buffers. When the response redundancy determining unit 23b determines that there is only one available buffer, the response redundancy determining unit 23b selects the available buffer as a buffer to store the response packet. Afterwards, the response redundancy determining unit 23b transmits, to the response redundancy processor 23c, a notification including information specifying the selected one or more buffers and information indicating that the response packet is not to be made redundant.

When the response redundancy determining unit 23b determines that a plurality of available buffers exist and even if the response is not of a type that causes a redundant response, the response redundancy determining unit 23b performs the following procedures in order to generate a redundant response. That is, when the response redundancy determining unit 23b determines that a plurality of available buffers exist, the response redundancy determining unit 23b selects, based on a prespecified number of response packets to be redundant, the response redundancy determining unit 23b selects the plurality of available buffers as buffers for storing the response packets.

For example, when the response packet that is a target of redundancy and a single response packet to be generated by copying the response packet that is a target of redundancy are to be stored, in other words when the prespecified number of response packets to be redundant is 2, the response redundancy determining unit 23b determines whether or not two or more available buffers exist. When the response packet that is a target of redundancy and two response packets to be generated by copying the response packet that is a target of redundancy are to be stored, in other words when the prespecified number of response packets to be redundant is 3, the response redundancy determining unit 23b determines whether or not three or more available buffers exist. When the response redundancy determining unit 23b determines that there is a plurality of available buffers whose number is equal to the prespecified number of response packets to be redundant, the response redundancy determining unit 23b selects all the plurality of available buffers.

When the response redundancy determining unit 23b determines that there is a plurality of available buffers whose number is larger than the prespecified number of response packets to be redundant, the response redundancy determining unit 23b uses a method, such as a round robin method, to select buffers from among the plurality of available buffers so that the number of the selected buffers is equal to the prespecified number of response packets to be redundant. Afterwards, the response redundancy determining unit 23b transmits, to the response redundancy processor 23c, a notification including information specifying the selected buffers and information indicating that the response packet is to be made redundant.

When the response redundancy determining unit 23b determines that not even one available buffer exists, the response redundancy determining unit 23b waits for a certain time period or waits until a buffer becomes available through the output of another response packet currently stored in any of the buffers 23d to 23g. After that, when a buffer becomes available, the response redundancy determining unit 23b selects the available buffer. When a plurality of buffers become available, the response redundancy determining unit 23b uses a method, such as round robin method, to select a buffer to store the response packet from among the plurality of available buffers. Afterwards, the response redundancy determining unit 23b transmits, to the response redundancy processor 23c, a notification that includes information indicating the selected single buffer and information indicating that the response packet is not to be made redundant.

When the response redundancy determining unit 23b determines that a response to be newly transmitted is of a type that causes a redundant response, the response redundancy processor 23c, which is described later, makes a response packet redundant by directing the transmission of the response packets stored in the selected available buffers. Even when the response redundancy determining unit 23b determines that the response that is to be newly transmitted is not of a type that causes a redundant response, when there is a plurality of available buffers, the response redundancy processor 23c makes the response packet redundant by directing the transmission of the response packets stored in the selected available buffers and then generates the redundant response packet.

Specifically, when the response redundancy determining unit 23b determines that at least one of the buffers 23d to 23g, which are provided for the transmission paths, is available, the response redundancy processor 23c generates a redundant response packet, which indicates that the response is not a type that causes a redundant response, and causes the response packets to be transmitted to the response receiver 13. Thus, the response redundancy determining unit 23b may reduce the possibility of retransmission of the response packet, which may be caused by a transmission error. The response redundancy determining unit 23b, for example, determines that a store response as well as an interrupt response provided by the calculating device 20 are responses that are of a type that causes a redundant response.

When the response redundancy processor 23c receives, from the response redundancy determining unit 23b, the notification that includes information specifying the plurality of buffers selected by the response redundancy determining unit 23b and information indicating that the response packet is to be made redundant, the response redundancy processor 23c instructs the response processor 21 to transmit the response packet and acquires the response packet from the response processor 21. Then, the response redundancy processor 23c copies the acquired response packet, depending on the number of redundant response packets or the prespecified number of response packets to be redundant, and causes the response packet and at least one copy of the response packet to be stored in the buffers indicated in the information, which specifies the selected buffers, that is included in the notification acquired from the response redundancy determining unit 23b.

If the response redundancy processor 23c receives, from the response redundancy determining unit 23b, a notification that includes information specifying a single buffer selected by the response redundancy determining unit 23b and information indicating that the response packet is to be made redundant, the response redundancy processor 23c instructs the response processor 21 to transmit the response packet and acquires the response packet from the response processor 21. Then, the response redundancy processor 23c causes the received response packet to be stored in the buffer indicated in the information, which specifies the buffer, that is included in the notification transmitted by the response redundancy determining unit 23b.

A transmitting device, which is the input/output processing device 10 or the calculating device 20 and which transmits redundant packets, may specify the maximum time interval of transmission of the redundant packets and guarantee that a receiving device, which is the input/output processing device 10 or the calculating device 20, receives the plurality of redundant packets within the maximum time interval. In this case, when transmission errors are continuously detected within the maximum time period, the receiving device treats the transmission errors as fatal errors. This may reduce if not prevent incorrect operation of the computer system 1 that may be caused by errors of transmission of all the redundant packets and losses of all the redundant packets.

For example, when the maximum time interval of the transmission of the redundant packets is 1 millisecond, the maximum time between the time to transmit the first redundant packet and the time to transmit the last redundant packet is 1 millisecond. When transmission errors are continuously detected within 1 millisecond, the receiving device determines that there is a possibility that all the redundant packets have encountered errors. The receiving device treats the errors as a fatal error, stops a process and generates an alarm. Stopping the process and the alarm may prevent the computer system 1 from incorrectly operating, that is, inhibit the computer system 1 from treating the request as an incomplete request due to losses of all the redundant packets and re-executing the request regardless of the case when the requested process actually finished.

For example, the request processor 11, the request transmitter 12, the request resource managing unit 12a, the request redundancy determining unit 12b, the request redundancy processor 12c, the response receiver 13, the error response packet discarding unit 13a, the redundant response packet discarding unit 13b and the SerDeses 12h to 12k are electronic circuits. The response processor 21, the request receiver 22, the error request packet discarding unit 22a, the redundant request packet discarding unit 22b, the response transmitter 23, the response resource managing unit 23a, the response redundancy determining unit 23b, the response redundancy processor 23c and the SerDeses 23h to 23k are electronic circuits, for example. Integrated circuits, such as application specific integrated circuits (ASICs) or field programmable gate arrays (FPGAs), may be used as the electronic circuits.

The buffers 12d to 12g and the buffers 23d to 23g are semiconductor memories, such as random access memories or flash memories, or are storage elements.

Process that the Request Transmitter 12 Performs

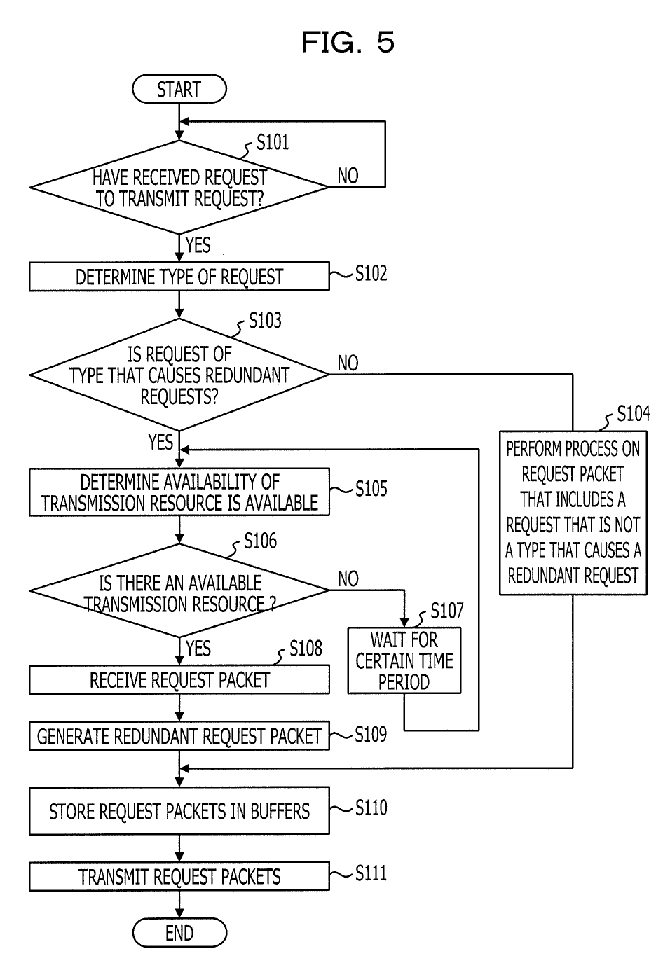

Next, an example of a process that is performed by the request transmitter 12 is described with reference to FIG. 5. FIG. 5 is a flowchart illustrating an example of the process that is performed by the request transmitter 12 to transmit a request packet. In the example illustrated in FIG. 5, the request transmitter 12 uses, as a trigger to perform the process, whether a request to transmit a request has been received (step S101). When the request transmitter 12 has not received a request to transmit the request (No in step S101), the request transmitter 12 temporarily waits and determines again whether a request to transmit a request has been received (step S101). When the request transmitter 12 receives a request to transmit a request (Yes in step S101), the request transmitter 12 determines the type of the request to be newly transmitted (step S102).

Then, the request transmitter 12 determines whether or not the determined type of the request causes a redundant request (step S103). When the request transmitter 12 determines that the determined type of the request does not cause a redundant request (No in step S103), the request transmitter 12 performs a process on a request packet that includes a request that is not of a type that causes a redundant request (step S104), and the request transmitter 12 causes the request packet to be stored in any of the buffers 12d to 12g (step S110). On the other hand, when the request transmitter 12 determines that the determined type of the request causes a redundant request (Yes in step S103), the request transmitter 12 determines whether or not an available transmission resource exists (step S105), in other words the request transmitter 12 determines whether or not an available buffer that may store the request packet exists.

When the request transmitter 12 determines that an available transmission resource does not exist (No in step S106), the request transmitter 12 waits for a certain time period (step S107) and determines again whether or not an available transmission resource exists (step S105). When the request transmitter 12 determines that an available transmission resource exists (Yes in step S106), the request transmitter 12 selects buffers to store redundant request packets and acquires the request packet from the request processor 11 (step S108). The request transmitter 12 generates a redundant request packet from the acquired request packet (step S109). The request transmitter 12 causes the redundant request packets to be stored in the selected buffers (step S110). After that, the request transmitter 12 transmits the request packets stored in the buffers 12d to 12g to the request receiver 22 (step S111). Then, the request transmitter 12 terminates the process.

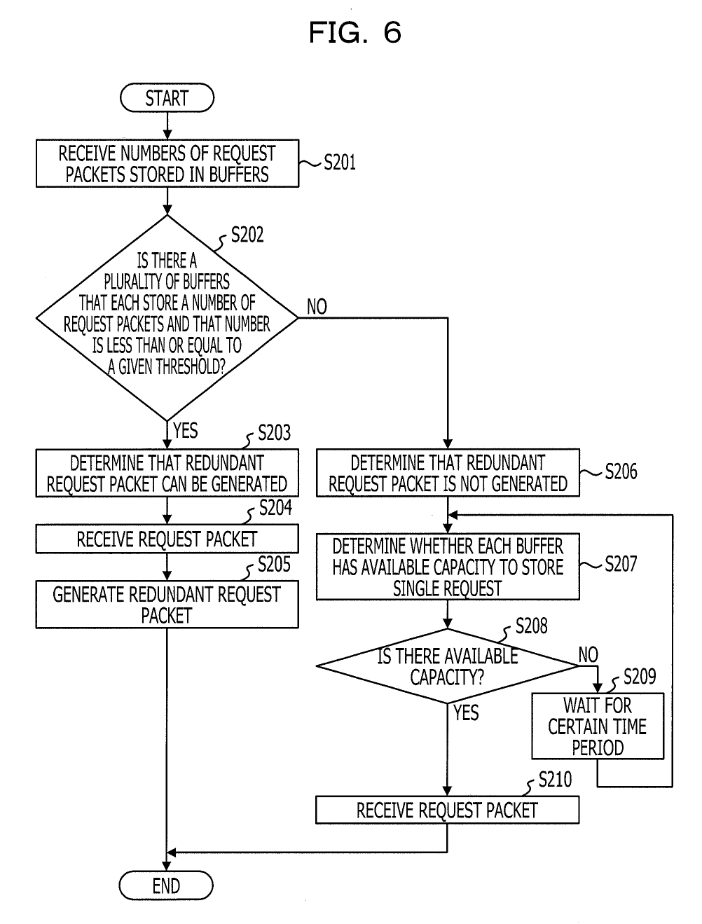

Next, the process that is performed on a request packet that includes a request that is not of a type that causes a redundant request is described with reference to FIG. 6. FIG. 6 is a diagram illustrating an example of the process that is performed by the request transmitter 12 according to the first embodiment in order to transmit the request packet that includes a request that is not of a type that causes the redundant request. Steps illustrated in FIG. 6 correspond to the process of step S104 illustrated in FIG. 5.

First, the request transmitter 12 receives information of the numbers of request packets stored in the buffers 12d to 12g (step S201). Then, the request transmitter 12 determines whether or not there is a plurality of buffers that each stores a number of request packets and that number is less than or equal to a given threshold (step S202). After that, when the request transmitter 12 determines that there is a plurality of buffers that each store a number of request packets and that number is less than or equal to the given threshold (Yes in step S202), the request transmitter 12 determines that the request transmitter 12 may generate a redundant request packet from the request packet and selects buffers to store the redundant request packets (step S203).

In this case, the request transmitter 12 receives the request packet from the request processor 11 (step S204) and generates the redundant request packet from the received request packet (step S205). After that, the request transmitter 12 terminates the process that is performed on the request packet that includes a request that is not of the type that causes a redundant request packet. Then, the request transmitter 12 causes the redundant request packets to be stored in the selected buffers that are different from each other (step S110 illustrated in FIG. 5).

When the request transmitter 12 determines that there is not a plurality of buffers that each store a number of request packets and that number is less than or equal to the given threshold (No in step S202), the request transmitter 12 determines that the request transmitter 12 does not generate a redundant request packet from the request packet (step S206). In this case, the request transmitter 12 determines whether or not each of the buffers 12d to 12g has available capacity to store the single request packet (step S207). Then, the request transmitter 12 determines whether or not any of the buffers 12d to 12g has available capacity to store the single request packet (step S208). When the request transmitter 12 determines that none of the buffers 12d to 12g has available capacity to store the single request packet (No in step S208), the request transmitter 12 waits for a certain time period (step S209). After that, the request transmitter 12 determines again whether or not each of the buffers 12d to 12g has available capacity to store the single request packet (step S207).

When the request transmitter 12 determines that any of the buffers 12d to 12g has available capacity to store the single request packet (Yes in step S208), the request transmitter 12 selects the buffer to store the request packet and receives the request packet from the request processor 11 (step S210). After that, the request transmitter 12 terminates the process for the request packet that includes a request that is not of a type that causes a redundant request packet. The request transmitter 12 does not generate a redundant request packet from the received request packet and causes the received packet to be stored in the selected buffer (step S110 illustrated in FIG. 5).

The response transmitter 23 generates a redundant response packet from the response packet that is a target of redundancy by performing a process that is the same as or similar to the process illustrated in FIGS. 5 and 6 that is performed by the request transmitter 12, and a description of the process is omitted.

### Effects of First Embodiment

As described above, the computer system 1 according to the first embodiment includes the input/output processing device 10 and the calculating device 20 that are connected to each other through the plurality of transmission paths. The input/output processing device 10 has the plurality of buffers 12d to 12g that temporarily store request packets to be transmitted through the transmission paths. The input/output processing device 10 counts the numbers of request packets stored in the buffers 12d to 12g. The input/output processing device 10 also determines whether or not a request to be transmitted to the calculating device 20 is of a type that causes a redundant request.

When the input/output processing device 10 determines that the request to be transmitted is not of a type that causes a redundant request, and there is a plurality of buffers that each store a number of request packets and that number is less than or equal to the given threshold, the input/output processing device 10 copies a request packet including the request and thereby generates a redundant request packet. After that, the input/output processing device 10 stores the request packet and the redundant request packet in different buffers and transmits the request packets to the calculating devices 20 through different transmission paths.

Thus, the input/output device 10 may reduce the number of times processing occurs to retransmit a request packet, which occurs when there is an available transmission path, the request packet is sent without generating a redundant request packet, and the request packet is discarded because of a transmission error. As a result, the computer system 1 may effectively use the transmission paths and may prevent a latency of data transmission from increasing.

The input/output processing device 10 determines that a request for a process that is performed by the calculating device 20 and whose order of procedures is desired to be guaranteed is a request of a type that causes a redundant request. Thus, when a request for a process is to be transmitted to the calculating device 20 and is not retransmitted to the calculating device 20, the computer system 1 generates a redundant request packet from a request packet including the request and may thereby prevent a fatal transmission error from occurring if the request was not executed because of a transmission error.

When the input/output processing device 10 does not receive a response to a request transmitted to the calculating device 20 within a given time period, the input/output processing device 10 transmits, to the calculating device 20, a request packet that includes the same request as the request transmitted to the calculating device 20. Thus, the computer system 1 may prevent a process that is to be performed by the calculating device 20 from being stopped if all the request packets are lost because of transmission errors.

The calculating device 20 discards a duplicate received request packet and a request packet for which a transmission error has occurred. The calculating device 20 performs a process indicated by a request included in a request packet that is not discarded, and transmits a response to the input/output processing device 10. Thus, the computer system 1 enables the calculating device 20 to perform an appropriate process, in other words may prevent the calculating device 20 from performing a duplicate process because of a redundant request and performing an inappropriate process because of the occurrence of a transmission error.

When the calculating device 20 determines that a response to be transmitted is not of a type that causes a redundant response, and there is a plurality of buffers that are among the buffers 23d to 23g and each store a number of response packets and that number is equal to or smaller than a given threshold, the calculating device 20 performs the following process in the same manner as the input/output processing device 10. That is, the calculating device 20 copies a response packet including the response, thereby generating a redundant response packet from the response packet, and transmits the response packet and the redundant response packet to the input/output processing device 10 through different transmission paths. Thus, the computer system 1 effectively uses the transmission paths, which are to be used to transmit response packets, and may prevent a latency of data transmission from increasing.

### Second Embodiment

The transmission system, the transmission system, and the method for controlling the transmission device disclosed herein may be applied to various embodiments other than the first embodiment. Examples of other embodiments are described below as a second embodiment.

### (1) Process of Generating Redundant Packet

When a request to be transmitted is not of a type that causes a redundant request, and the buffers 12d to 12g have available capacity to store redundant packets, the request transmitter 12 copies a request packet including the request and thereby generates a redundant request packet. The request transmitter 12, however, is not limited to the first embodiment. The request transmitter 12 uses an arbitrary method to determine whether or not a plurality of available transmission paths exist. When a plurality of available transmission paths exist, the request transmitter 12 may copy the request packet and thereby generate the redundant request packet. For example, when the request transmitter 12 detects buffers that are among the buffers 12d to 12g and each store a number of request packets and that number is smaller than a given threshold, and the number of the detected buffers is larger than the number of request packets to be redundant, the request transmitter 12 may determine that the request to be transmitted is to be made redundant.

In addition, the request transmitter 12 may determine, based on the numbers of request packets stored in the buffers 12d to 12g and information indicating whether or not a request to be transmitted exists, whether or not a request packet is to be made redundant.

For example, the request processor 11 may have a buffer to temporarily store a request acquired through the input/output device controller 15, and transmit, to the request transmitter 12, a request to transmit the request stored in the buffer. In this case, the request processor 11 determines whether or not the buffer stores a request other than the request transmitted to the request transmitter 12. In other words, the request processor 11 determines whether or not a subsequent request exists.

When the request processor 11 determines that the subsequent request exists, the request processor 11 transmits, to the request transmitter 12, a request to transmit both the request and information that indicates that the subsequent request exists. In this case, the request transmitter 12 determines that a request to be transmitted to the calculating device 20 exists as a request succeeding the request to be newly transmitted. When the request transmitter 12 determines that a request to be transmitted to the calculating device 20 exists as the request succeeding the request to be newly transmitted, and even if there is a buffer that is among the buffers 12d to 12g and stores a number of request packets and that number is smaller than a given number, the request transmitter 12 does not copy the request packet. In other words, when the request to be newly transmitted is not of a type that causes a redundant request, even if a transmission path is available, if a subsequent request exists, the request transmitter 12 transmits the request packet to the calculating device 20 without generating a redundant request packet.

If the request processor 11 determines that the subsequent request does not exist, the request processor 11 transmits, to the request transmitter 12, only the request to transmit the request. In this case, the request transmitter 12 performs the same process as the first embodiment. That is, when the request transmitter 12 determines that the request to be transmitted is not of a type that causes a redundant request and any of the buffers 12d to 12g stores a number of request packets and that number is smaller than the given number, the request processor 11 copies the request packet including the request and thereby generates a redundant request packet.

In this manner, the request transmitter 12 generates a redundant request packet from the request packet including a type that causes a redundant request, and may prevent a latency of transmission for the subsequent request from increasing. As a result, the computer system 1 appropriately uses the transmission paths and may prevent a latency of data transmission from increasing.

### (2) Input/Output Processing Device and Calculating Device

In the computer system 1, the input/output processing device 10 and the calculating device 20 are connected to each other through the plurality of transmission paths and transmit and receive request packets and response packets using the serial transmission method. The computer system 1 is not limited to the first embodiment. The techniques disclosed herein may be applied to a transmission system in which arbitrary devices are connected to each other through a plurality of transmission paths.

### (3) Selection of Buffer for Storing Packet

The request redundancy determining unit 12b uses a method, such as a round robin method, to select, from among the buffers 12d to 12g that may store a request packet, a buffer to store the request packet. The request redundancy determining unit 12b is not limited to the first embodiment. The request redundancy determining unit 12b may select, from among buffers that may store request packets, a buffer whose number of stored request packets is smallest. In addition, the request redundancy determining unit 12b may select, from among buffers whose number of stored packets are smallest, buffers whose number is equal to the number of request packets to be generated by copying a request packet.

In the same manner, the response redundancy determining unit 23b may select, from among buffers that may store response packets, a buffer that stores the smallest number of response packets. The response redundancy determining unit 23b may select, from among buffers that each store response packets whose numbers are smallest, buffers whose number is equal to the number of response packets to be generated by copying a response packet.

### (4) Process Causing Packet to be Made Redundant

The request redundancy determining unit 12b determines that a process that is performed whose order of procedures is desired to be guaranteed by the calculating device 20, such as a store request or an interrupt request, is a process for which the request is to be made redundant. However, the processes whose request is made redundant is not limited to these. That is, since the techniques disclosed herein may be applied to a transmission system in which arbitrary devices are connected to each other through a plurality of transmission paths, wherein arbitrary requests may be made redundant and transmitted and received between the devices.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission system comprising:
a first device; and
a second device that is connected to the first device through a plurality of transmission paths,
wherein the first device includes
a plurality of request storage units that are provided for the transmission paths and each store a request to be transmitted to the second device,
a request determining unit that determines whether a request to be transmitted to the second device is of a type that causes a redundant request,
a request resource determining unit that counts the number of the requests stored in each of the plurality of request storage units and determines the number of request storage units that each store a number of requests whose counted number is less than equal to a given threshold,
a request storing unit that causes a plurality of requests, generated by copying the request to be transmitted, to be stored in a plurality of distinct request storage units among the plurality of request storage units, and causes the plurality of requests to be stored in one of the request storage units when the request determining unit determines that the request to be transmitted is not of the type that causes a redundant request and the request resource determining unit determines that there is not a plurality of request storage units that each store a number of requests whose counted number is less than or equal to the given threshold, and
a plurality of request transmitters that transmit the requests stored in the plurality of storage units through distinct transmission paths among the plurality of transmission paths.

2. The transmission system according to claim 1, wherein
the request determining unit determines that a request for a process whose order of procedures is desired to be guaranteed is of the type that causes a redundant request.

3. The transmission system according to claim 1, wherein
the first device further includes
a response receiver that receives a response to a request transmitted to the second device, and
a timer that counts an amount of time from the transmission of the request until the reception of the response to the request by the response receiver, and
wherein the request storing unit retransmits the request when the amount of time that is counted by the timer exceeds a given amount.

4. The transmission system according to claim 1, wherein
the second device includes
a request receiver that receives the requests from the first device through the transmission paths and discards a duplicate request from among the received requests and a request in which a transmission error has occurred from among the received requests, and
a response processor that transmits, to the first device, a response to a request that is not discarded by the request receiver.

5. The transmission system according to claim 4, wherein
the response processor includes
a plurality of response storage units that are provided for the transmission paths and each store a response to be transmitted to the first device,
a plurality of response transmitters that transmit the responses stored in the plurality of response storage units to the first device through distinct transmission paths among the plurality of transmission paths,
a response determining unit that determines whether a response to be transmitted to the first device is of a type that causes a redundant response,
a response resource determining unit that counts the numbers of the responses stored in the plurality of response storage units and determines the number of response storage units that each store a number of responses whose counted number is less than or equal to a given threshold, and
a response storing unit that causes a plurality of responses, generated by copying the response to be transmitted, to be stored in a plurality of distinct response storage units among the plurality of response storage units when the response determining unit determines that the response to be transmitted is of the type that causes a redundant response or when the response determining unit determines that the response to be transmitted is not of the type that causes a redundant response and the response resource determining unit determines that there is a plurality of response storage units that each store a number of responses whose counted number is less than or equal to the given threshold, and that causes the plurality of responses, generated by copying the response to be transmitted, to be stored in any of the response storage units when the response determining unit determines that the response to be transmitted is not of the type causing the redundant response and the response resource determining unit determines that there is not a plurality of response storage units that each store a number of responses whose counted number is less than or equal to the given threshold do not exist.

6. The transmission system according to claim 3, wherein
the first device further includes
a subsequent request determining unit that determines whether a request to be transmitted to the second device is a subsequent request of the request to be transmitted,
wherein the request storing unit causes the plurality of requests, generated by copying the request to be transmitted, to be stored in distinct request storage units among the plurality of request storage units when the request determining unit determines that the request to be transmitted is of the type that causes a redundant request or when the request determining unit determines that the request to be transmitted is not of the type that causes a redundant request, the request resource determining unit determines that there is a plurality of request storage units that each store a number of requests whose counted number is less than or equal to the given threshold, and the subsequent request determining unit determines that the subsequent request does not exist, and
wherein the request storing unit causes the plurality of requests, generated by copying the request to be transmitted, to be stored in any of the request storage units, and the plurality of request transmitters to transmit the requests stored in the request storage units, when the request determining unit determines that the request to be transmitted is not of the type that causes a redundant request, and the subsequent request determining unit determines that the subsequent request exists.

7. The transmission system according to claim 1, wherein
the first device is an input/output processing device that performs an input and output process for a computer system, and
wherein the second device is a calculating device that performs a calculation process for the computer system.

8. A transmission device comprising:
a plurality of request storage units that are provided for a plurality of transmission paths and store requests to be transmitted through the plurality of transmission paths to another device connected to the request storage units;
a request determining unit that determines whether a request to be transmitted to the other device is of a type that causes a redundant request;
a request resource determining unit that counts the numbers of the requests stored in the plurality of request storage units and determines the number of request storage units that each store a number of requests whose counted number is less than or equal to a given threshold;
a request storing unit that causes a plurality of requests, generated by copying the request to be transmitted, to be stored in distinct request storage units among the plurality of request storage units when the request determining unit determines that the request to be transmitted is of the type that causes a redundant request or when the request determining unit determines that the request to be transmitted is not of the type that causes a redundant request and the request resource determining unit determines that there is a plurality of request storage units that each store a number of requests whose counted number is less than or equal to the given threshold, and that causes the plurality of requests, generated by copying the request to be transmitted, to be stored in any of the plurality of request storage units when the request determining unit determines that the request to be transmitted is not of the type that causes a redundant request and the request resource determining unit determines that there is not a plurality of request storage units that each store a number of requests whose counted number is less than or equal to the given threshold do not exist; and
a plurality of request transmitters that transmit the requests stored in the plurality of request storage units to the other device through distinct transmission paths among the plurality of transmission paths.

9. A method for controlling a transmission device provided with a plurality of storage units that store requests to be transmitted to another device connected to the transmission device through a plurality of transmission paths, the method comprising:
determining whether a request to be transmitted to the other device is of a type that causes a redundant request;
counting the numbers of the requests stored in the plurality of storage units and determining the number of storage units that each store a number of requests whose counted number is less than or equal to a given threshold;
storing a plurality of requests, generated by copying the request to be transmitted, in distinct storage units among the plurality of storage units when it is determined that the request to be transmitted is of a type that causes a redundant request or when it is determined that the request to be transmitted is not of a type that causes a redundant request and that there is a plurality of storage units that each store a number of requests whose counted number is less than or equal to the given threshold;
storing the plurality of requests, generated by copying the request to be transmitted, in any of the plurality of storage units when it is determined that the request to be transmitted is not of the type that causes a redundant request and that there is not a plurality of storage units that each store a number of requests whose counted number is less than or equal to the given threshold; and
transmitting the requests stored in the plurality of storage units to the other device through distinct transmission paths among the plurality of transmission paths.
